(19) United States
(12) Patent Application Publication
(10) Pub. No.: US 2025/0061673 A1
(43) Pub. Date: Feb. 20, 2025

(54) NORMAL-REGULARIZED CONFORMAL DEFORMATION FOR STYLIZED THREE DIMENSIONAL (3D) MODELING

(71) Applicant: Roblox Corporation, San Mateo, CA (US)

(72) Inventors: Hsueh-Ti Derek Liu, Vancouver (CA); Maurice Kyojin CHU, Redwood City, CA (US); Dario KNEUBUHLER, Lucerne (CH); Andrew Alan JOHNSON, Minneapolis, MN (US)

(73) Assignee: Roblox Corporation, San Mateo, CA (US)

(21) Appl. No.: 18/770,776

(22) Filed: Jul. 12, 2024

Related U.S. Application Data
(60) Provisional application No. 63/532,550, filed on Aug. 14, 2023.

(51) Int. Cl. G06T 19/20

(52) U.S. Cl. CPC G06T 19/20; G06T 2219/2004; G06T 2219/2016; G06T 2219/2021

(57) ABSTRACT

Some implementations relate to methods, systems, and computer-readable media to stylize a three-dimensional (3D) avatar in a virtual experience using controls to set constraints. The stylizing may include performing applying a scaling control to a body part of the avatar body to change a size of at least one component of the body part, applying a positional control to the body part of the avatar body to change at least one from the group of a shape of the at least one component of the body part, a position of the at least one component of the body part, and a combination thereof, and/or applying an orientation control to the body part of the avatar body to change an orientation of the at least one component of the body part; and deforming the body part of the avatar body accordingly based on minimizing an energy function.

### CROSS-REFERENCE TO RELATED APPLICATIONS

This application claims priority to U.S. Provisional Application No. 63/532,550, entitled “NORMAL-REGULARIZED CONFORMAL DEFORMATION FOR STYLIZED THREE-DIMENSIONAL (3D) MODELING,” filed on Aug. 14, 2023, the content of which is incorporated herein in its entirety.

### TECHNICAL FIELD

This disclosure relates generally to computer graphics, and more particularly but not exclusively, relates to methods, systems, and computer readable media to stylize a three-dimensional (3D) avatar.

### BACKGROUND

The development of various digital geometry processing techniques has lowered the difficulty of creating graphical 3D objects. Several techniques, such as non-uniform rational B-splines modeling (NURBS), constructive solid geometry, recursive bicubic B-spline patch subdivision, digital sculpting, etc., have been incorporated into various software products. However, creating 3D digital content remains a tedious process that involves participation by a large number of artists to meticulously model a 3D shape. For example, creating a high quality virtual experience (such as an electronic game) may still involve significant time and effort by hundreds of developers, artists, etc.

Some implementations were conceived in light of the above.

The background description provided herein is for the purpose of presenting the context of the disclosure. Work of the presently named inventors, to the extent it is described in this background section, as well as aspects of the description that may not otherwise qualify as prior art at the time of filing, are neither expressly nor impliedly admitted as prior art against the prior disclosure.

### SUMMARY

Implementations of the present disclosure relate to stylizing bodies of three-dimensional (3D) avatars. For example, the stylizing uses a variety of techniques to obtain high quality results while minimizing human labor and computational resources. As an example, the stylizing may deform a body part of a 3D avatar body based on user input.

For example, the techniques may include performing at least one from the group comprising applying a scaling control, applying a positional control, and applying an orientation control, and combinations thereof to a body part of a 3D avatar body. The techniques may also include deforming the body part of the 3D avatar body based on minimizing an energy function associated with the at least one applied control from the group comprising the scaling control, the positional control, and the orientation control, and combinations thereof.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by a data processing apparatus, cause the apparatus to perform the actions.

According to one aspect, a computer-implemented method to stylize a three-dimensional (3D) avatar body is provided, the method comprising: performing at least one from the group comprising: applying a scaling control to a body part of the avatar body to change a size of at least one component of the body part; applying a positional control to the body part of the avatar body to change at least one from the group of a shape of the at least one component of the body part, a position of the at least one component of the body part, and a combination thereof; applying an orientation control to the body part of the avatar body to change an orientation of the at least one component of the body part; and combinations thereof; and deforming the body part of the avatar body based on minimizing an energy function associated with at least one from the group comprising: the scaling control, the positional control, the orientation control, and combinations thereof.

Various implementations of the computer-implemented method are described herein.

In some implementations, minimizing the energy function comprises using a local-global solver to perform a local step and a global step, wherein the local step comprises computing an optimal rotation by solving a singular value decomposition and the global step comprises solving a system of linear equations.

In some implementations, applying the positional control comprises satisfying at least one positional constraint by adding positional constraints when performing the global step.

In some implementations, applying the scaling control comprises specifying a target scale at respective vertices of a mesh of the body part of the avatar body.

In some implementations, applying the positional control comprises manipulating at least one of the shape and the position of the at least one component of the body part to satisfy at least one positional constraint.

In some implementations, applying the orientation control comprises controlling surface normals of the at least one component to satisfy at least one orientation constraint.

In some implementations, controlling surface normals comprises setting target normals to closest cubic shape normals.

In some implementations, the body part of the avatar body comprises a head.

In some implementations, the at least one component of the body part includes one or more from the group of: a jaw, lips, eyes, ears, a forehead, eyebrows, eyelashes, cheeks, a chin, a nose, a face, hair, and combinations thereof.

According to another aspect, a non-transitory computer-readable medium is provided. The non-transitory computer-readable medium with instructions stored thereon that, responsive to execution by a processing device, causes the processing device to perform operations to stylize a three-dimensional (3D) avatar body comprising: performing at least one from the group comprising: applying a scaling control to a body part of the avatar body to change a size of at least one component of the body part; applying a positional control to the body part of the avatar body to change at least one from the group of a shape of the at least one component of the body part, a position of the at least one component of the body part, and a combination thereof; applying an orientation control to the body part of the avatar body to change an orientation of the at least one component of the body part; and combinations thereof; and deforming the body part of the avatar body based on minimizing an energy function associated with at least one from the group comprising: the scaling control, the positional control, the orientation control, and combinations thereof.

Various implementations of the non-transitory computer-readable medium are described herein.

In some implementations, minimizing the energy function comprises using a local-global solver to perform a local step and a global step, wherein the local step comprises computing an optimal rotation by solving a singular value decomposition and the global step comprises solving a system of linear equations.

In some implementations, applying the positional control comprises satisfying at least one positional constraint by adding positional constraints when performing the global step.

In some implementations, applying the scaling control comprises specifying a target scale at respective vertices of a mesh of the body part of the avatar body.

In some implementations, wherein applying the positional control comprises manipulating at least one of the shape and the position of the at least one component of the body part to satisfy at least one positional constraint.

In some implementations, applying the orientation control comprises controlling surface normals of the at least one component to satisfy at least one orientation constraint.

According to another aspect, a system is disclosed, comprising: a memory with instructions stored thereon; and a processing device, coupled to the memory, the processing device configured to access the memory, wherein the instructions when executed by the processing device cause the processing device to perform operations to stylize a three-dimensional (3D) avatar body comprising: performing at least one from the group comprising: applying a scaling control to a body part of the avatar body to change a size of at least one component of the body part; applying a positional control to the body part of the avatar body to change at least one from the group of a shape of the at least one component of the body part, a position of the at least one component of the body part, and a combination thereof; applying an orientation control to the body part of the avatar body to change an orientation of the at least one component of the body part; and combinations thereof; and deforming the body part of the avatar body based on minimizing an energy function associated with at least one from the group comprising: the scaling control, the positional control, the orientation control, and combinations thereof.

Various implementations of the system are described herein.

In some implementations, minimizing the energy function comprises using a local-global solver to perform a local step and a global step, wherein the local step comprises computing an optimal rotation by solving a singular value decomposition and the global step comprises solving a system of linear equations.

In some implementations, applying the positional control comprises satisfying at least one positional constraint by adding positional constraints when performing the global step.

In some implementations, applying the scaling control comprises specifying a target scale at respective vertices of a mesh of the body part of the avatar body.

In some implementations, applying the orientation control comprises controlling surface normals of the at least one component to satisfy at least one orientation constraint.

According to yet another aspect, portions, features, and implementation details of the systems, methods, and non-transitory computer-readable media may be combined to form additional aspects, including some aspects which omit and/or modify some or portions of individual components or features, include additional components or features, and/or other modifications, and all such modifications are within the scope of this disclosure.

### BRIEF DESCRIPTION OF THE DRAWINGS

FIG. 1 is a diagram of an example system architecture that includes a 3D environment platform that can support the creation of stylized 3D avatars, in accordance with some implementations.

FIG. 2 illustrates an example of a 3D stylization technique, in accordance with some implementations.

FIG. 3 illustrates an example of a scaling control, in accordance with some implementations.

FIG. 4 illustrates an example of a positional control, in accordance with some implementations.

FIG. 5 illustrates an example of an orientation control, in accordance with some implementations.

FIG. 6 illustrates an example of the application of one or more of the controls of FIGS. 3-5, in accordance with some implementations.

FIG. 7 illustrates an example of the application of positional controls so as to satisfy positional constraints, in accordance with some implementations.

FIG. 8 illustrates an example of the application of orientation controls, in accordance with some implementations.

FIG. 9 is a flowchart of an example computer-implemented method executable in a three-dimensional (3D) environment to stylize a three-dimensional (3D) avatar body, in accordance with some implementations.

FIG. 10 is a flowchart of an example computer-implemented method executable in a three-dimensional (3D) environment to implement stylizing a three-dimensional (3D) avatar body, in accordance with some implementations.

FIG. 11 is a block diagram illustrating an example computing device, in accordance with some implementations.

### DETAILED DESCRIPTION

In the following detailed description, reference is made to the accompanying drawings, which form a part hereof. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented herein. Aspects of the present disclosure, as generally described herein, and illustrated in the Figures, can be arranged, substituted, combined, separated, and designed in a wide variety of different configurations, all of which are contemplated herein.

References in the specification to “one implementation,” “an implementation,” “an example implementation,” etc. indicate that the implementation described may include a particular feature, structure, or characteristic, but every implementation may not necessarily include the particular feature, structure, or characteristic. Moreover, such phrases are not necessarily referring to the same implementation. Further, when a particular feature, structure, or characteristic is described in connection with an implementation, such feature, structure, or characteristic may be effected in connection with other implementations whether or not explicitly described.

The present disclosure is directed towards, inter alia, stylizing the shape of a three-dimensional (3D) avatar (e.g., stylizing the shape of an animated head of the avatar with facial expressions) to exhibit variants of the avatar, wherein facial expressions transferred to the head are of high quality. Such techniques may involve more than merely getting the shape of the stylized head correct. For example, the formlines of the triangulation or another transferring method used for generating the facial expression may be factors in obtaining good quality animated facial expressions and/or deformations.

The implementations disclosed herein reduce human effort in creating 3D content, such as with respect to digital sculpting and shape deformation. Some techniques may be based on preserving volume and local rigidity, including techniques that may use a Kelvinlets brush and/or an as-rigid-as-possible approach. These techniques offer intuitive controls when a user wishes to pose a character.

For example, modeling 3D content (especially stylized avatars) would require volume changes. For instance, changing a realistic human avatar to have a cartoonish style may include significant volume changes near an eye region.

Other techniques, such as Kelvinlet sculpting brushes and as-rigid-as possible shape deformation, are designed to prevent volume changes. This is a desirable property to, for instance, pose a human character, but this property prevents modeling stylized 3D content because volume change is often involved.

However, such techniques may not be well-suited without modification for modeling stylized content because stylized content (such as 3D avatars) often involve exaggerating certain geometric components, such as enlarging eyes for cartoon characters. These geometric exaggerations may violate constraints on volume preservation, making existing volume-preserving deformation techniques impractical.

Other techniques for 3D stylization to resolve these issues involve turning a given shape into a cubic style, extending the stylization to different polygonal primitives, etc. One or more of these techniques may be based on the injection of scaling and surface normals as two additional components in a volume-preserving objective function.

Thus, some implementations provide an intuitive 3D modeling system inspired by existing 3D stylization research. Instead of providing detailed controls on every single element on a 3D shape, implementations offer intuitive and easy to use control structures to manipulate a shape. Using these approaches, an ordinary user can easily create 3D content according to various user preferences. The user uses controls to indicate user preferences to model 3D content, and these preferences are integrated into the 3D content by implementations, producing high-stylized results.

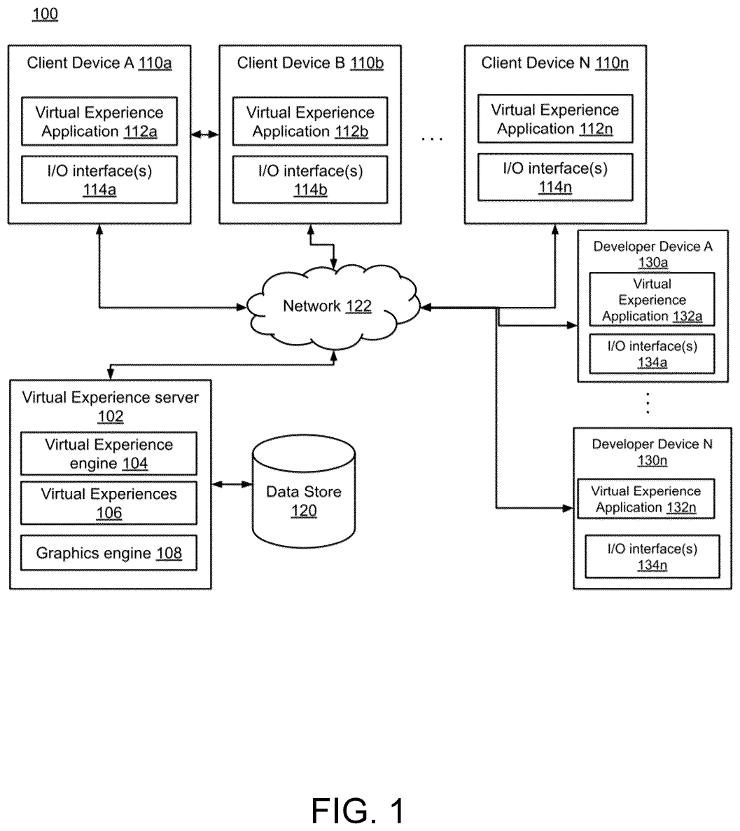

### FIG. 1—System Architecture

FIG. 1 is a diagram of an example system architecture that includes a 3D environment platform that can support the creation of stylized 3D avatars, in accordance with some implementations. FIG. 1 and the other figures use like reference numerals to identify similar elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g., “110” in the text refers to reference numerals “110a,” “110b,” and/or “110n” in the figures).

The system architecture 100 (also referred to as “system” herein) includes online virtual experience server 102, data store 120, client devices 110a, 110b, and 110n (generally referred to as “client device(s) 110” herein), and developer devices 130a and 130n (generally referred to as “developer device(s) 130” herein). Virtual experience server 102, data store 120, client devices 110, and developer devices 130 are coupled via network 122. In some implementations, client devices(s) 110 and developer device(s) 130 may refer to the same or same type of device.

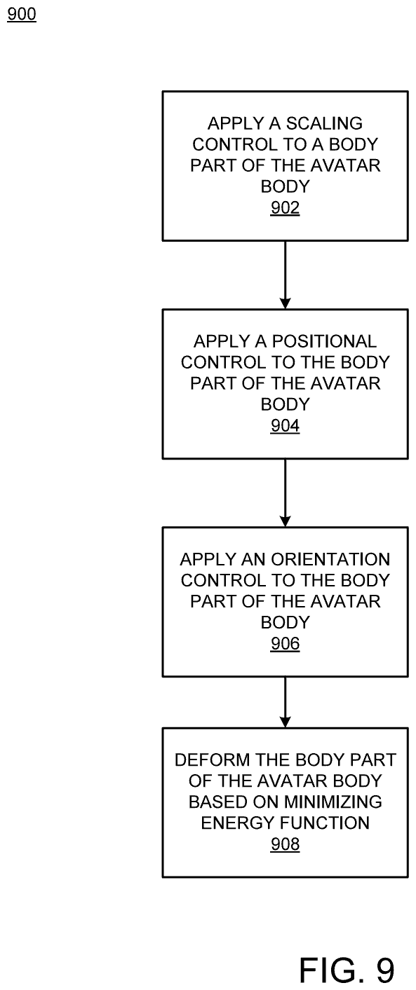

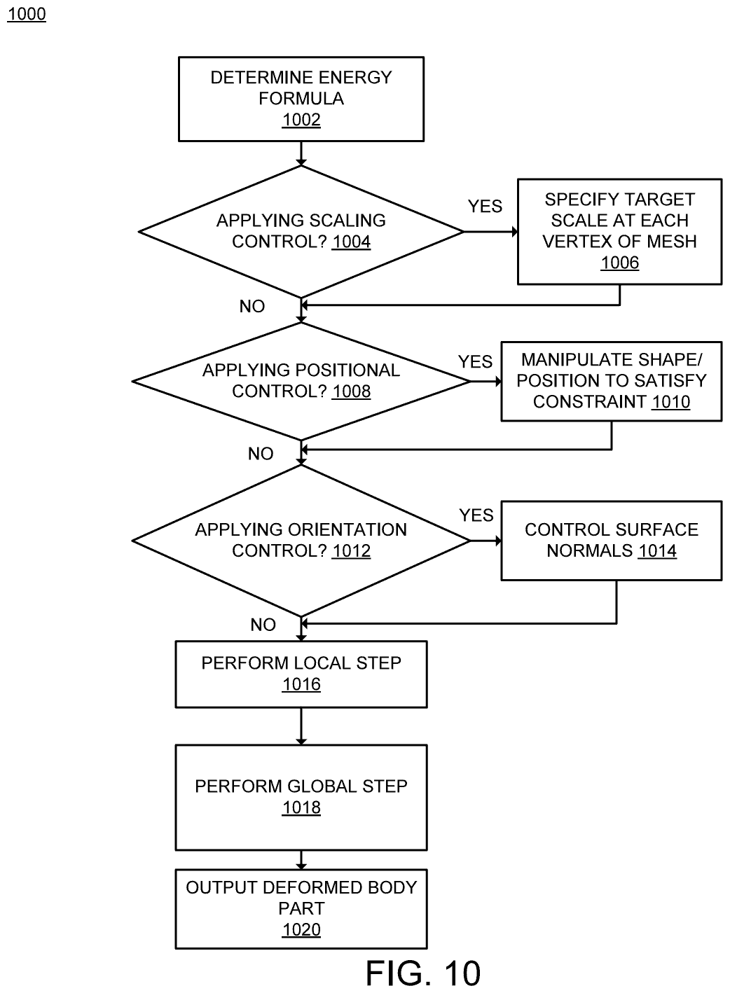

Online virtual experience server 102 can include, among other things, a virtual experience engine 104, one or more virtual experiences 106, and graphics engine 108. In some implementations, the graphics engine 108 may be a system, application, or module that permits the online virtual experience server 102 to provide graphics and animation capability. In some implementations, the graphics engine 108 may perform one or more of the operations described below in connection with the flowcharts shown in FIGS. 9-10. A client device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture 100 is provided for illustration. In different implementations, the system architecture 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., Ethernet network), a wireless network (e.g., an 802.11 network, a Wi-Fi® network, or wireless LAN (WLAN)), a cellular network (e.g., a 5G network, a Long Term Evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, or another type of component or device capable of storing data. The data store 120 may also include multiple storage components (e.g., multiple drives or multiple databases) that may also span multiple computing devices (e.g., multiple server computers). In some implementations, data store 120 may include cloud-based storage.

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on client devices 110.

In some implementations, virtual experience session data are generated via online virtual experience server 102, virtual experience application 112, and/or virtual experience application 132, and are stored in data store 120. With permission from virtual experience participants, virtual experience session data may include associated metadata, e.g., virtual experience identifier(s); device data associated with the participant(s); demographic information of the participant(s); virtual experience session identifier(s); chat transcripts; session start time, session end time, and session duration for each participant; relative locations of participant avatar(s) within a virtual experience environment; purchase(s) within the virtual experience by one or more participants(s); accessories utilized by participants; etc.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., 1:1 and/or N:N synchronous and/or asynchronous text-based communication). A record of some or all user communications may be stored in data store 120 or within virtual experiences 106. The data store 120 may be utilized to store chat transcripts (text, audio, images, etc.) exchanged between participants.

In some implementations, the chat transcripts are generated via virtual experience application 112 and/or virtual experience application 132 or and are stored in data store 120. The chat transcripts may include the chat content and associated metadata, e.g., text content of chat with each message having a corresponding sender and recipient(s); message formatting (e.g., bold, italics, loud, etc.); message timestamps; relative locations of participant avatar(s) within a virtual experience environment, accessories utilized by virtual experience participants, etc. In some implementations, the chat transcripts may include multilingual content, and messages in different languages from different sessions of a virtual experience may be stored in data store 120.

In some implementations, chat transcripts may be stored in the form of conversations between participants based on the timestamps. In some implementations, the chat transcripts may be stored based on the originator of the message(s).

In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.”

In some implementations, online virtual experience server 102 may be a virtual gaming server. For example, the gaming server may provide single-player or multiplayer games to a community of users that may access as “system” herein) includes online gaming server 102, data store 120, client or interact with virtual experiences using client devices 110 via network 122. In some implementations, virtual experiences (including virtual realms or worlds, virtual games, other computer-simulated environments) may be two-dimensional (2D) virtual experiences, three-dimensional (3D) virtual experiences (e.g., 3D user-generated virtual experiences), virtual reality (VR) experiences, or augmented reality (AR) experiences, for example. In some implementations, users may participate in interactions (such as gameplay) with other users. In some implementations, a virtual experience may be experienced in real-time with other users of the virtual experience.

In some implementations, virtual experience engagement may refer to the interaction of one or more participants using client devices (e.g., 110) within a virtual experience (e.g., 106) or the presentation of the interaction on a display or other output device (e.g., 114) of a client device 110. For example, virtual experience engagement may include interactions with one or more participants within a virtual experience or the presentation of the interactions on a display of a client device.

In some implementations, a virtual experience 106 can include an electronic file that can be executed or loaded using software, firmware or hardware configured to present the virtual experience content (e.g., digital media item) to an entity. In some implementations, a virtual experience application 112 may be executed and a virtual experience 106 rendered in connection with a virtual experience engine 104. In some implementations, a virtual experience 106 may have a common set of rules or common goal, and the environment of a virtual experience 106 shares the common set of rules or common goal. In some implementations, different virtual experiences may have different rules or goals from one another.

In some implementations, virtual experiences may have one or more environments (also referred to as “virtual experience environments” or “virtual environments” herein) where multiple environments may be linked. An example of an environment may be a three-dimensional (3D) environment. The one or more environments of a virtual experience 106 may be collectively referred to as a “world” or “virtual experience world” or “gaming world” or “virtual world” or “universe” herein. An example of a world may be a 3D world of a virtual experience 106. For example, a user may build a virtual environment that is linked to another virtual environment created by another user. A character of the virtual experience may cross the virtual border to enter the adjacent virtual environment.

It may be noted that 3D environments or 3D worlds use graphics that use a three-dimensional representation of geometric data representative of virtual experience content (or at least present virtual experience content to appear as 3D content whether or not 3D representation of geometric data is used). 2D environments or 2D worlds use graphics that use two-dimensional representation of geometric data representative of virtual experience content.

In some implementations, the online virtual experience server 102 can host one or more virtual experiences 106 and can permit users to interact with the virtual experiences 106 using a virtual experience application 112 of client devices 110. Users of the online virtual experience server 102 may play, create, interact with, or build virtual experiences 106, communicate with other users, and/or create and build objects (e.g., also referred to as “item(s)” or “virtual experience objects” or “virtual experience item(s)” herein) of virtual experiences 106.

For example, in generating user-generated virtual items, users may create characters, decoration for the characters, one or more virtual environments for an interactive virtual experience, or build structures used in a virtual experience 106, among others. In some implementations, users may buy, sell, or trade virtual experience objects, such as in-platform currency (e.g., virtual currency), with other users of the online virtual experience server 102. In some implementations, online virtual experience server 102 may transmit virtual experience content to virtual experience applications (e.g., 112). In some implementations, virtual experience content (also referred to as “content” herein) may refer to any data or software instructions (e.g., virtual experience objects, virtual experience, user information, video, images, commands, media item, etc.) associated with online virtual experience server 102 or virtual experience applications. In some implementations, virtual experience objects (e.g., also referred to as “item(s)” or “objects” or “virtual objects” or “virtual experience item(s)” herein) may refer to objects that are used, created, shared or otherwise depicted in virtual experience applications 106 of the online virtual experience server 102 or virtual experience applications 112 of the client devices 110. For example, virtual experience objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration. In some implementations, online virtual experience server 102 may host one or more media items that can include communication messages from one user to one or more other users. With user permission and express user consent, the online virtual experience server 102 may analyze chat transcripts data to improve the virtual experience platform. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual experience 106 may be associated with a particular user or a particular group of users (e.g., a private virtual experience), or made widely available to users with access to the online virtual experience server 102 (e.g., a public virtual experience). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

In some implementations, online virtual experience server 102 or client devices 110 may include a virtual experience engine 104 or virtual experience application 112. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the virtual experience (e.g., rendering commands, collision commands, physics commands, etc.) In some implementations, virtual experience applications 112 of client devices 110, respectively, may work independently, in collaboration with virtual experience engine 104 of online virtual experience server 102, or a combination of both.

In some implementations, both the online virtual experience server 102 and client devices 110 may execute a virtual experience engine (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of client device 110. In some implementations, each virtual experience 106 may have a different ratio between the virtual experience engine functions that are performed on the online virtual experience server 102 and the virtual experience engine functions that are performed on the client devices 110. For example, the virtual experience engine 104 of the online virtual experience server 102 may be used to generate physics commands in cases where there is a collision between at least two virtual experience objects, while the additional virtual experience engine functionality (e.g., generate rendering commands) may be offloaded to the client device 110. In some implementations, the ratio of virtual experience engine functions performed on the online virtual experience server 102 and client device 110 may be changed (e.g., dynamically) based on virtual experience engagement conditions. For example, if the number of users engaging in a particular virtual experience 106 exceeds a threshold number, the online virtual experience server 102 may perform one or more virtual experience engine functions that were previously performed by the client devices 110.

For example, users may be playing a virtual experience 106 on client devices 110, and may send control instructions (e.g., user inputs, such as right, left, up, down, user election, or character position and velocity information, etc.) to the online virtual experience server 102. Subsequent to receiving control instructions from the client devices 110, the online virtual experience server 102 may send experience instructions (e.g., position and velocity information of the characters participating in the group experience or commands, such as rendering commands, collision commands, etc.) to the client devices 110 based on control instructions. For instance, the online virtual experience server 102 may perform one or more logical operations (e.g., using virtual experience engine 104) on the control instructions to generate experience instruction(s) for the client devices 110. In other instances, online virtual experience server 102 may pass one or more or the control instructions from one client device 110 to other client devices (e.g., from client device 110a to client device 110b) participating in the virtual experience 106. The client devices 110 may use the experience instructions and render the virtual experience for presentation on the displays of client devices 110.

In some implementations, the control instructions may refer to instructions that are indicative of actions of a user's character within the virtual experience. For example, control instructions may include user input to control action within the experience, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a client device 110 to another client device (e.g., from client device 110b to client device 110n), where the other client device generates experience instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, experience instructions may refer to instructions that enable a client device 110 to render a virtual experience, such as a multiparticipant virtual experience. The experience instructions may include one or more of user input (e.g., control instructions), character position and velocity information, or commands (e.g., physics commands, rendering commands, collision commands, etc.).

In some implementations, characters (or virtual experience objects generally) are constructed from components, one or more of which may be selected by the user, that automatically join together to aid the user in editing.

In some implementations, a character is implemented as a 3D model and includes a surface representation used to draw the character (also known as a skin or mesh) and a hierarchical set of interconnected bones (also known as a skeleton or rig). The rig may be utilized to animate the character and to simulate motion and action by the character. The 3D model may be represented as a data structure, and one or more parameters of the data structure may be modified to change various properties of the character, e.g., dimensions (height, width, girth, etc.); body type; movement style; number/type of body parts; proportion (e.g., shoulder and hip ratio); head size; etc.

One or more characters (also referred to as an “avatar” or “model” herein) may be associated with a user where the user may control the character to facilitate a user's interaction with the virtual experience 106.

In some implementations, a character may include components such as body parts (e.g., hair, arms, legs, etc.) and accessories (e.g., t-shirt, glasses, decorative images, tools, etc.). In some implementations, body parts of characters that are customizable include head type, body part types (arms, legs, torso, and hands), face types, hair types, and skin types, among others. In some implementations, the accessories that are customizable include clothing (e.g., shirts, pants, hats, shoes, glasses, etc.), weapons, or other tools.

In some implementations, for some asset types, e.g., shirts, pants, etc. the online virtual experience platform may provide users access to simplified 3D virtual object models that are represented by a mesh of a low polygon count, e.g., between about 20 and about 30 polygons.

In some implementations, the user may also control the scale (e.g., height, width, or depth) of a character or the scale of components of a character. In some implementations, the user may control the proportions of a character (e.g., blocky, anatomical, etc.). It may be noted that is some implementations, a character may not include a character virtual experience object (e.g., body parts, etc.) but the user may control the character (without the character virtual experience object) to facilitate the user's interaction with the virtual experience (e.g., a puzzle game where there is no rendered character game object, but the user still controls a character to control in-game action).

In some implementations, a component, such as a body part, may be a primitive geometrical shape such as a block, a cylinder, a sphere, etc., or some other primitive shape such as a wedge, a torus, a tube, a channel, etc. In some implementations, a creator module may publish a user's character for view or use by other users of the online virtual experience server 102. In some implementations, creating, modifying, or customizing characters, other virtual experience objects, virtual experiences 106, or virtual experience environments may be performed by a user using a I/O interface (e.g., developer interface) and with or without scripting (or with or without an application programming interface (API)). It may be noted that for purposes of illustration, characters are described as having a humanoid form. It may further be noted that characters may have any form such as a vehicle, animal, inanimate object, or other creative form.

In some implementations, the online virtual experience server 102 may store characters created by users in the data store 120. In some implementations, the online virtual experience server 102 maintains a character catalog and virtual experience catalog that may be presented to users. In some implementations, the virtual experience catalog includes images of virtual experiences stored on the online virtual experience server 102. In addition, a user may select a character (e.g., a character created by the user or other user) from the character catalog to participate in the chosen virtual experience. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the client device(s) 110 may each include computing devices such as personal computers (PCs), mobile devices (e.g., laptops, mobile phones, smart phones, tablet computers, or netbook computers), network-connected televisions, gaming consoles, etc. In some implementations, a client device 110 may also be referred to as a “user device.” In some implementations, one or more client devices 110 may connect to the online virtual experience server 102 at any given moment. It may be noted that the number of client devices 110 is provided as illustration. In some implementations, any number of client devices 110 may be used.

In some implementations, each client device 110 may include an instance of the virtual experience application 112, respectively. In one implementation, the virtual experience application 112 may permit users to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to client device 110 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application may be an online virtual experience server application for users to build, create, edit, upload content to the online virtual experience server 102 as well as interact with online virtual experience server 102 (e.g., engage in virtual experiences 106 hosted by online virtual experience server 102). As such, the virtual experience application may be provided to the client device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual experience hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, virtual experience program, or a gaming program) that is installed and executes local to developer device 130 and allows users to interact with online virtual experience server 102. The virtual experience application may render, display, or present the content (e.g., a web page, a media viewer) to a user. In an implementation, the virtual experience application may also include an embedded media player (e.g., a Flash® or HTML5 player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or engage in virtual experiences 106 hosted by online virtual experience server 102). As such, the virtual experience application may be provided to the client device(s) 130 by the online virtual experience server 102. In another example, the virtual experience application 132 may be an application that is downloaded from a server. Game application 132 may be configured to interact with online virtual experience server 102 and obtain access to user credentials, user currency, etc. for one or more virtual experiences 106 developed, hosted, or provided by a virtual experience developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience developer may obtain access to virtual experience virtual objects, such as in-platform currency (e.g., virtual currency), avatars, special powers, accessories, that are owned by or associated with other users.

In general, functions described in one implementation as being performed by the online virtual experience server 102 can also be performed by the client device(s) 110, or a server, in other implementations if appropriate. In addition, the functionality attributed to a particular component can be performed by different or multiple components operating together. The online virtual experience server 102 can also be accessed as a service provided to other systems or devices through suitable application programming interfaces (APIs), and thus is not limited to use in websites.

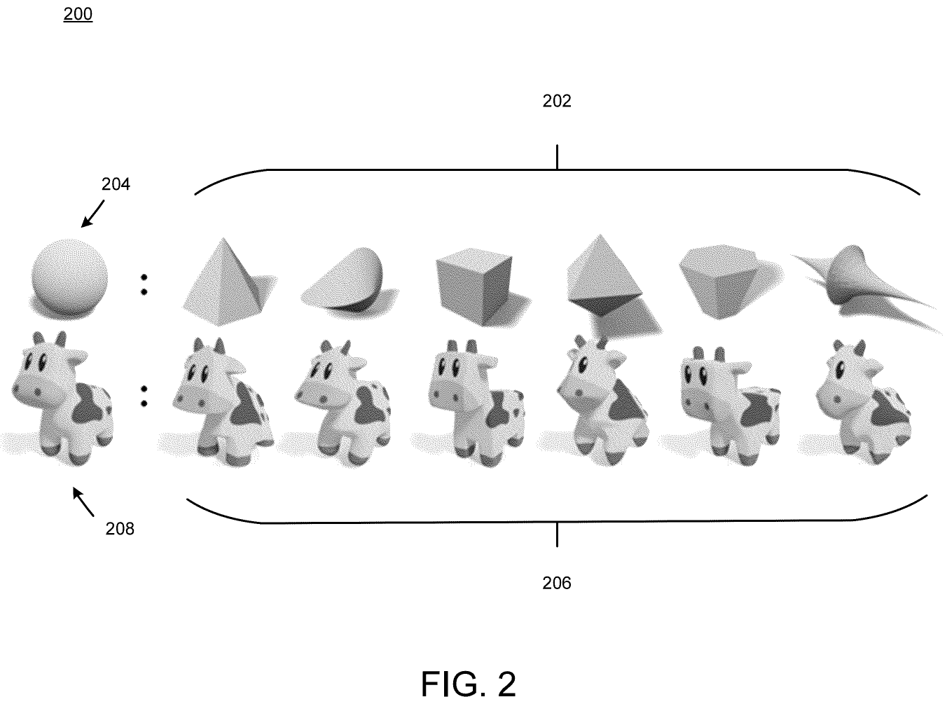

### FIG. 2—Example 3D Stylization Technique

FIG. 2 illustrates an example of a 3D stylization technique 200, in accordance with some implementations. Given a polygonal primitive, a method may deform an input shape into different styles by injecting local orientation constraints into the input shape. For example, the initial input shape may be a sphere 204. The input shape may be a calf 208. FIG. 2 illustrates a variety of polygonal primitives 202, including a pyramid, a curved solid, a cube, an octahedron, a polyhedral frustum, and a top-shaped shape (listed from left to right). Based on the polygonal primitives 202, the method may result in deformed input shapes 206. Each of the deformed input shapes 206 is based on the original calf 208, stylized in keeping with a corresponding one of the polygon primitives 202. Such styling imparts aspects of the appearance of the corresponding polygon primitive 202 into the deformed input shape 206.

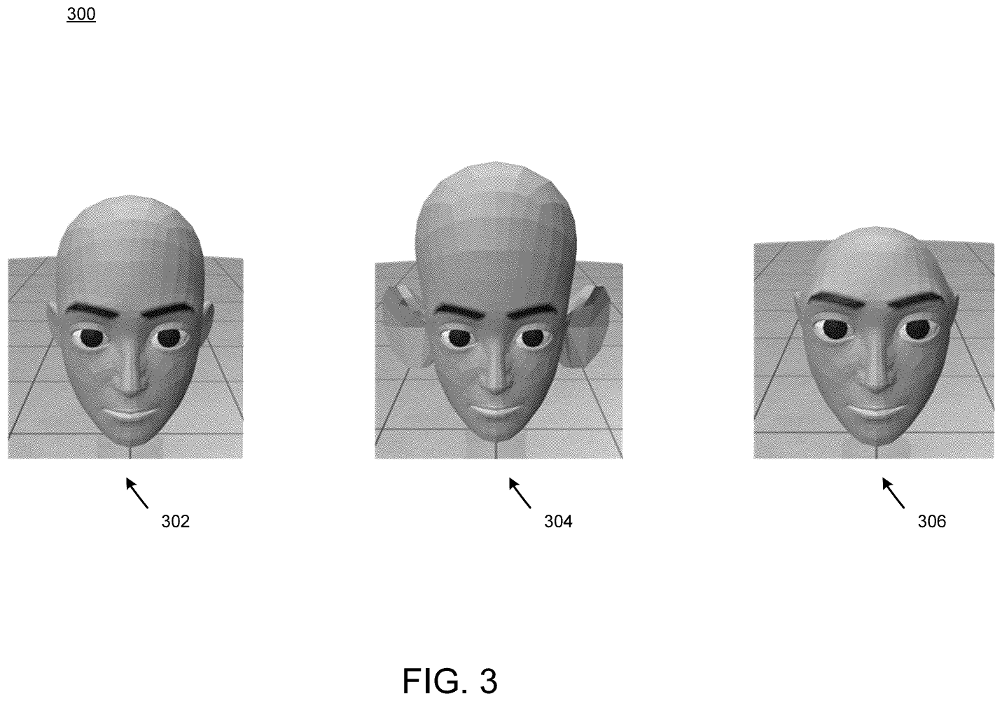

### FIG. 3—Scaling Control

FIG. 3 illustrates an example of a scaling control 300, in accordance with some implementations. Such a scaling control permits creators to scale components of a 3D shape, such as scaling the top of a head and the cars of an avatar up and down. With respect to scaling, creators or other users may scale components of a 3D shape. In FIG. 3, scaling components of a 3D model 302 are controlled, such as by making the top of the head and the cars larger in a 3D model 304, or by making the top head and the cars smaller in a 3D model 306. FIG. 3 also illustrates that scaling the ears and the head top in 3D model 304 or 3D model 306 does not affect other aspects of the avatar head in 3D model 302, such as eyebrows, eyes, nose, lips, chin, and so on. Instead, only a specific portion of the avatar head (e.g., the top of the head and the ears) is scaled.

Various user interface techniques and approaches may be used to indicate how the user wishes to perform the scaling. For example, a mouse may be used to click on an area to scale, and then the mouse may be dragged to set an amount of the scaling. Another approach would be to use a touchscreen, such that a user would touch an area to scale, and then an appropriate gesture such as a pinching gesture could set an amount of the scaling. However, the use of a mouse or touchscreen is not limiting, and other interface tools such as a keyboard or a microphone could provide textual instructions or verbal instructions to control the scaling. Thus, any interface that allows a user to indicate which portion of a 3D shape to scale and how much and in what direction to scale the 3D shape may be used.

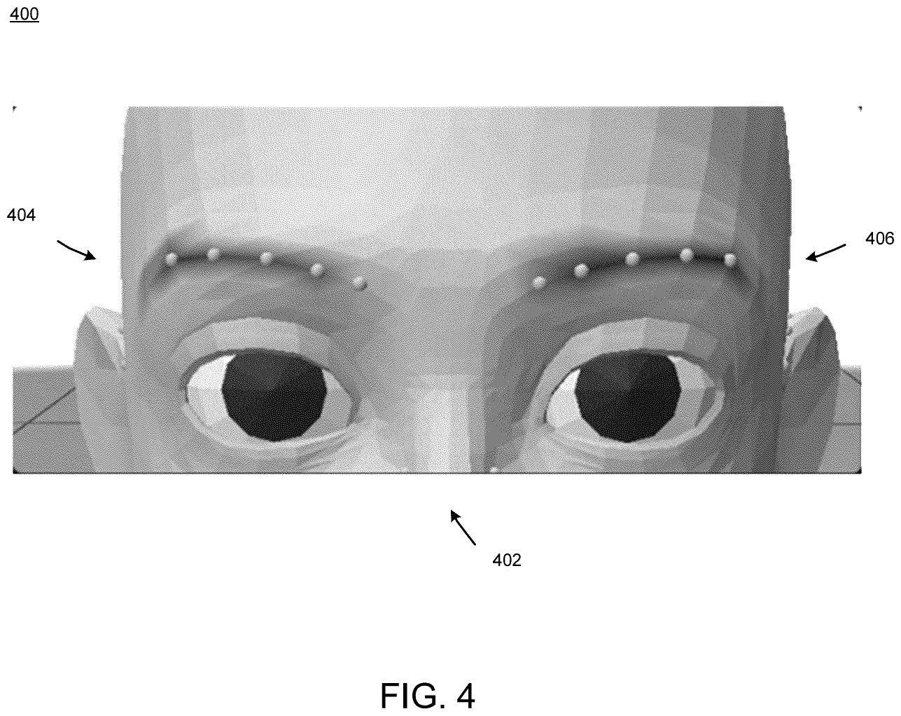

### FIG. 4—Positional Control

FIG. 4 illustrates an example of a positional control 400, in accordance with some implementations. Such a positional control 400 permits creators to pin down certain parts of the shape in order to control the shape and positions of the pinned portions. For example, a view of the user's eyes and eyebrows as 3D model 402 illustrates that implementations include control points 404 that act as anchors for the user's right eyebrow and control points 406 that act as anchors for the user's left eyebrow. Thus, the control points 404 and the control points 406 act as positional constraints that control the location and the shape of components. In FIG. 4, control points 404 and control points 406 constrain these aspects of each eyebrow.

FIG. 4 illustrates an implementation in which the control points define eyebrows that are symmetrically positioned and shaped. In other implementations, the control points 404 and the control points 406 may deviate from this symmetric definition. For example, one eyebrow may be defined by control points 404 that specify an ordinary position and the other eyebrow may be defined by control points 406 that are lifted and distorted, defining an arched eyebrow used to indicate curiosity or concern.

Various user interface techniques and approaches may be used to indicate how the user wishes to perform the positional control. For example, a mouse may be used to click on areas in an image to define control points for the positional control. Another approach would be to use a touchscreen, such that a user would touch areas on the image to define control points. However, the use of a mouse or touchscreen is not limiting, and other interface tools such as a keyboard or a microphone could provide textual instructions or verbal instructions to control and/or place the positional controls. Thus, any interface that allows a user to indicate control points for a positional control may be used.

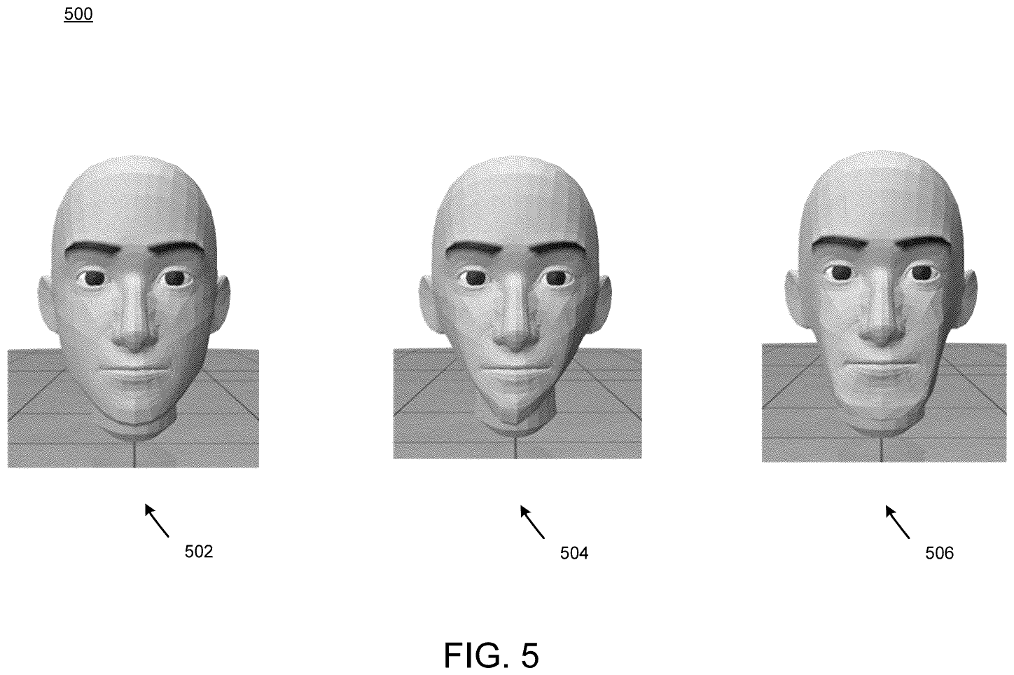

### FIG. 5—Orientation Control

FIG. 5 illustrates an example of an orientation control 500, in accordance with some implementations. With respect to orientation constraints, creators or other users may control the orientation (e.g., surface normals) of surface patches. For example, the orientation constraint enables the control of the shape of a jaw (i.e., how is the jaw surface oriented as a surface). FIG. 5 illustrates an example of an orientation control, in accordance with some implementations. In FIG. 5, the surface normals of a 3D model 502 are controlled, thereby leading to the controlling of the shape of the face to be V-shaped in a 3D model 504 or squared-shaped in a 3D model 506.

Various user interface techniques and approaches may be used to indicate how the user wishes to perform the orientation control. For example, a mouse may be used to click on an area with an orientation to modify, and then the mouse may be dragged to indicate how to modify the orientation (e.g., how to modify surface normal). Another approach would be to use a touchscreen, such that a user would touch an area with an orientation to modify, and then an appropriate gesture such as a pinching gesture could indicate how to modify an orientation. However, the use of a mouse or touchscreen is not limiting, and other interface tools such as a keyboard or a microphone could provide textual instructions or verbal instructions to control the orientation modification. Thus, any interface that allows a user to indicate which portion of a 3D shape to control an orientation and provide conditions for modifying the orientation may be used.

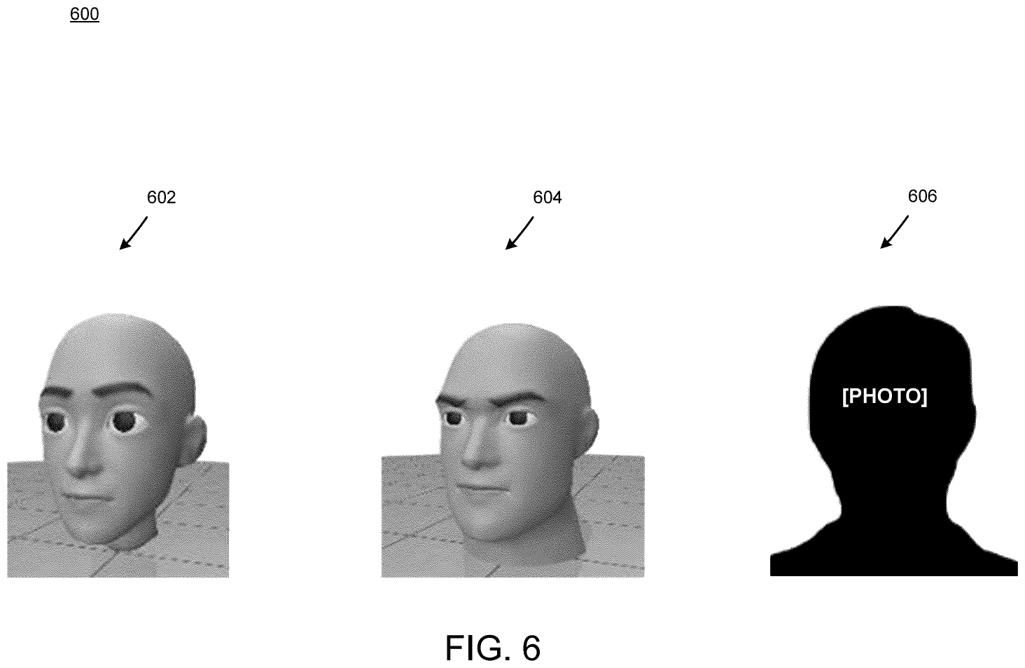

### FIG. 6—Application of Controls

FIG. 6 illustrates an example 600 of the application of one or more of the controls of FIGS. 3-5, in accordance with some implementations. As discussed above, various user interface techniques may provide implementations with input about the scaling control, positional control, and orientation control information input by the user.

One or more of the above three controls (scaling control, positional control, orientation control) may be used in creating 3D avatar heads that mimic an appearance from a photo or other image. FIG. 6 illustrates an example of the application of one or more of the controls of FIGS. 3-5, in accordance with some implementations. In FIG. 6, an input avatar head 602 is transformed into the deformed avatar head 604 that looks closer to an image of actual person (represented by a generic and symbolic form in FIG. 6) provided in a photo 606.

According to various implementations, a method deforms a mesh by minimizing an energy function E corresponding to the mesh. The rationale behind using such an energy function is that it is difficult to communicate to a computer whether a deformation is plausible or not. Thus, implementations use a mathematical formula (the energy formula) that takes a mesh as the input and outputs a number. This number may indicate to the computer whether the proposed deformation is good or bad. For example, a number with a high value may indicate a bad deformation, while a number with a low value may indicate a good deformation.

Once there is a way to generate such a number, implementations can then create a plausible deformation by finding a mesh that provides a small energy value (i.e., energy minimization). This energy-based approach for deformation has been shown to be an effective technique to get more plausible deformations. Various implementations are an instance of this approach, compared to non-energy based methods (e.g., linear blend skinning).

This type of energy-based deformation can be written in a general form, V′=arg min_{V′}E(V, V′, F) (Equation 1). In Equation 1, V represents the vertex locations of the input triangle mesh, V′ are the vertex locations of the output mesh, and F are the face indices of the input/output mesh. The deformation is assumed to keep the mesh connectivity F the same before and after the deformation occurs.

One implementation of the deformer is based on an energy that is a mixture of as-conformal-as-possible with an L2 regularization on surface normals. For example, the energy can be written as follows: E(V′, R, S)=Σ_{k∈V}Σ_{ij∈N(k)}wᵢⱼ∥sₖRₖ(vⱼ−vᵢ)−(v′ⱼ−vᵢ′)∥²+λₖaₖ∥Rₖnₖ−tₖ∥² (Equation 2).

In Equation 2, k denotes the index to vertex k, ij∈N(k) are the spokes-and-rims edge indices at the one-ring of k, wᵢⱼ is the cotangent weight associated with each half-edge ij, sₖ is the scaling factor at vertex k, Rₖ is a 3D rotation matrix at k, vᵢ, v′ᵢ denote the input and output vertex locations, respectively, λₖ is a scalar weighting parameter on the normal term at k, nₖ is the normal vector on the input mesh, and tₖ is the target normal vector at k. This target normal is used as a design parameter to preserve the input shape (by setting tₖ=nₖ) or turn the input shape to a different style (e.g. cubic style by setting tₖ be the closest axis-aligned normal vector of nₖ).

The energy (as defined in Equation 2), may include two terms. First, there may be an as conformal as possible term. This term measures whether the three angles of each triangle are preserved after the shape deformation. Intuitively, this energy looks at every triangle in the mesh, measures the three angles before and after the deformation, and if the difference is small, the energy value is small (meaning good deformation), and vice versa. At the high level, this angle measurement allows each triangle to scale (uniformly scaling a triangle does not change its angles). The outcome of this measure is a more visually smooth deformation like the figures presented herein. Such a deformation is visually plausible and thus implementations use this angle difference as a measure for whether the deformation is good or not.

Second, there may be an L2 regularization on surface normal term. This term measures, for each triangle, the squared L2 difference between the normal vector of the triangle on the deformed mesh and a target normal vector tₖ. If tₖ is the normal vector from the un-deformed input mesh, then implementations are making the technique preserve the input style (as much as possible) after deformation. If tₖ is, for instance, a normal vector that aligns with one of the axes, then implementations are causing the deformation to make the shape look like a blocky character.

An implementation of the deformer may be based on minimizing this energy subject to point constraints using a local-global solver. Specifically, the local step involves computing the optimal rotation Rₖ by solving a small 3×3 singular value decomposition, followed by computing the optimal value to scale sₖ. It has been proven that such a solution corresponds to the solution to the famous “Orthogonal Procrustes” problem. This approach is used as the local step due to efficiency. The approach is inspired by a class of optimization algorithms called Coordinate Descent. The approach used in these algorithms is to minimize one variable at a time (the optimal rotation at each vertex), instead of all variables together (all rotations and deformed vertex locations). This makes the solve a lot more efficient because optimizing a single variable is extremely fast, and it can still converge to a local minimum. Implementations thus use this type of local step to keep the algorithm efficient.

The global step can be cast as solving a system of linear equations. Such a system of linear equations can be compactly written as QV′=B, where V′ is an N×3 matrix of the deformed vertex locations, Q is an N×N matrix, and B is an N×3 matrix. Q and B depend on user input parameters (e.g, scaling, target normal, rotations, etc.) and are chosen using mathematical optimization techniques from such parameters.

With respect to controlling the scale, the scaling control can be used to prescribe the value(s) of a target scale of each vertex sₖ (see, e.g., above Equation 2). Such value(s) influence the local step in the optimizer (e.g., changes the output Rₖ in Equation 2) and thus influences the global solve. Specifically, the values of B would be affected.

With respect to positional constraints, implementations of the positional control can be realized by setting constraints on the global step (e.g., solving a system of linear equations). For example, let the system of linear equations in the global step be as follows: Ax=b (Equation 3) which corresponds to minimizing a quadratic energy E(x)=1/2 x′Ax−x′b+constant (Equation 4). Equation 2 can be rewritten into a quadratic form of ax²+bx+c after the local step (such that rotations have been computed). Such rewriting may involve using matrices and linear algebra to provide such a formulation.

Adding positional constraints cᵢ means that the following optimization problem is to be solved (as a minimization problem based on Equation 4): minₓ 1/2 x′Ax−x′b+constant, subject to xᵢ=cᵢ for all i in the constraints.

The above optimization problem can be solved by removing the known values xᵢ=cᵢ from the quadratic energy E in order to reformulate the problem as another linear system solution problem with slightly different left hand side and right hand side, such as the following: A′x′=b′ (Equation 5). In Equation 5, x′ is used to denote the unknown variables in x. Then, the concatenation of x′, {cᵢ} may be the final solution that satisfies the positional constraints.

There may be several techniques to find a solution that satisfies the positional constraints. One example technique is to separate the energy into knowns and unknowns, and then solve for the unknowns by setting a gradient with respect to those unknowns to zero. Another example technique is to add an additional term to the energy that punishes not satisfying the known values of constant constraints in the least squares sense, then solve for all variables by setting the gradient with respect to all variables to zero. Yet another example technique is to add additional variables called Lagrange multipliers to the energy so that the problem is longer to find a minimum but to find a stationary point in the new energy. Such a stationary point guarantees that our constraints are met. It may be possible to find the stationary point by a method of setting the gradient to zero, but in this technique the gradient is with respect to all of the original variables and also the new variables. These positional constraints may be used to manipulate the shape and the position of individual components in an optimized manner.

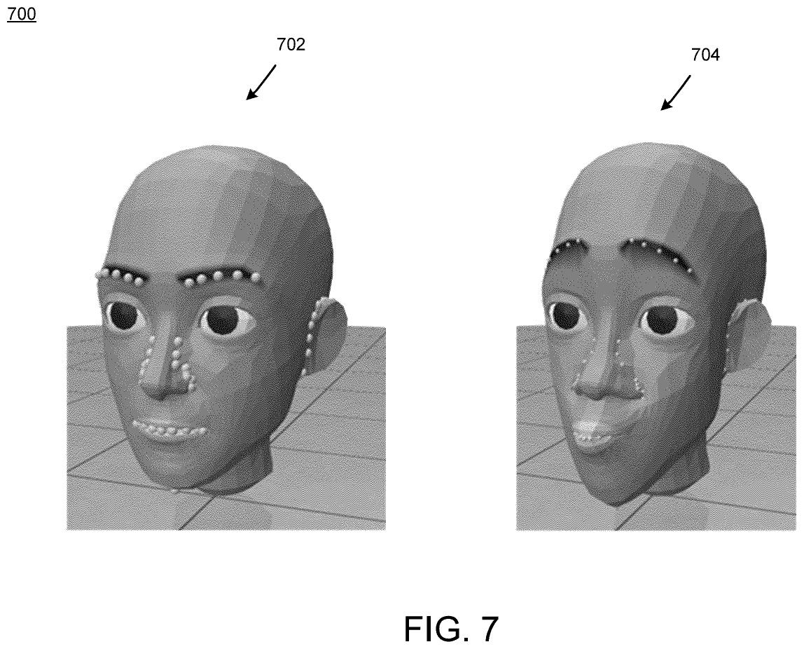

### FIG. 7—Application of Positional Controls

FIG. 7 illustrates an example of the application of positional controls so as to satisfy positional constraints 700, in accordance with some implementations. In the example of FIG. 7, positional controls are used to control (e.g., change) the shape and location of the mouth, nose, ears, and eyebrows between 3D avatars 702 and 704. Hence, the positional controls are able to modify facial expressions, by changing these portions of the facial expression.

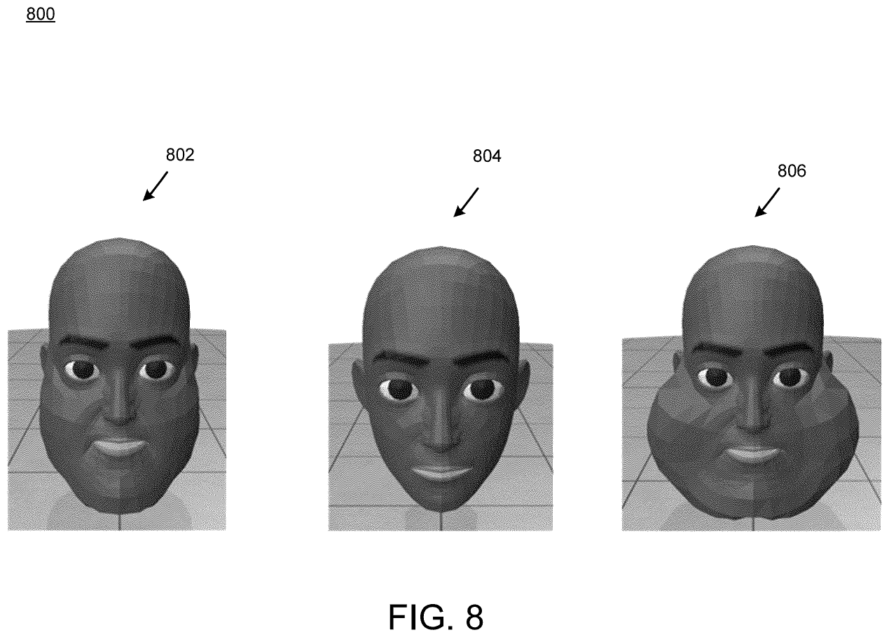

### FIG. 8—Application of Orientation Controls

FIG. 8 illustrates an example of the application of orientation controls 800, in accordance with some implementations. With respect to orientation constraints, implementations of the orientation control may be based on specifying target normal vectors tₖ in the above Equation 2. Intuitively understood, the target normals control the style of the model by incorporating orientations of constituent faces of the model.

A first use case may include setting tₖ=nₖ (Equation 6), such that the target normal vectors are equal to the input normals. This use case leads to a style preserving deformation implementation in that the normal vectors are not changed between input and output. FIG. 8 illustrates an example of the application of orientation controls, in accordance with some implementations. More specifically, FIG. 8 illustrates examples of disabling the normal term (λ=0, such as in Equation 1) versus enabling the normal term with tₖ=nₖ (as in Equation 6).

Thus, enabling the normal term and preserving the input normals may regularize and/or control the deformation behavior in a certain way (e.g., manage modifications and/or deformation as shown at 802). If the user wishes to stylize a shape (e.g., make a change), the user can choose tₖ to be something else to control the overall shape. For example, a different choice of tₖ leads to a different orientation of the outer surface of the model.

FIG. 8 illustrates the control of a jaw shape. FIG. 8 illustrates enabling the normal(s) at 802, the original jaw shape at 804, and disabling the normal(s) at 806. Different jaw shapes may be generated by setting the target normal to the closest normals, such as to a cubic shape normal as follows: tₖ=ClosestCubicNormal(nₖ) (Equation 7). A cubic shape normal may be used in an illustrative implementation. In other implementations, the cubic shape normal may be replaced with other choices of normal vectors. Choices of which normal vectors to use may be an artistic design decision. For a cubic normal specifically, the cubic normal is implemented by finding the closest axis-aligned normal vector (e.g., [1, 0, 0], [−1, 0, 0], [0, 1, 0], etc.) for each vertex normal vector.

### FIG. 9—Stylizing a 3D Avatar Body

FIG. 9 is a flowchart of an example computer-implemented method 900 executable in a three-dimensional (3D) environment to stylize a three-dimensional (3D) avatar body, in accordance with some implementations. Method 900 may begin at block 902.

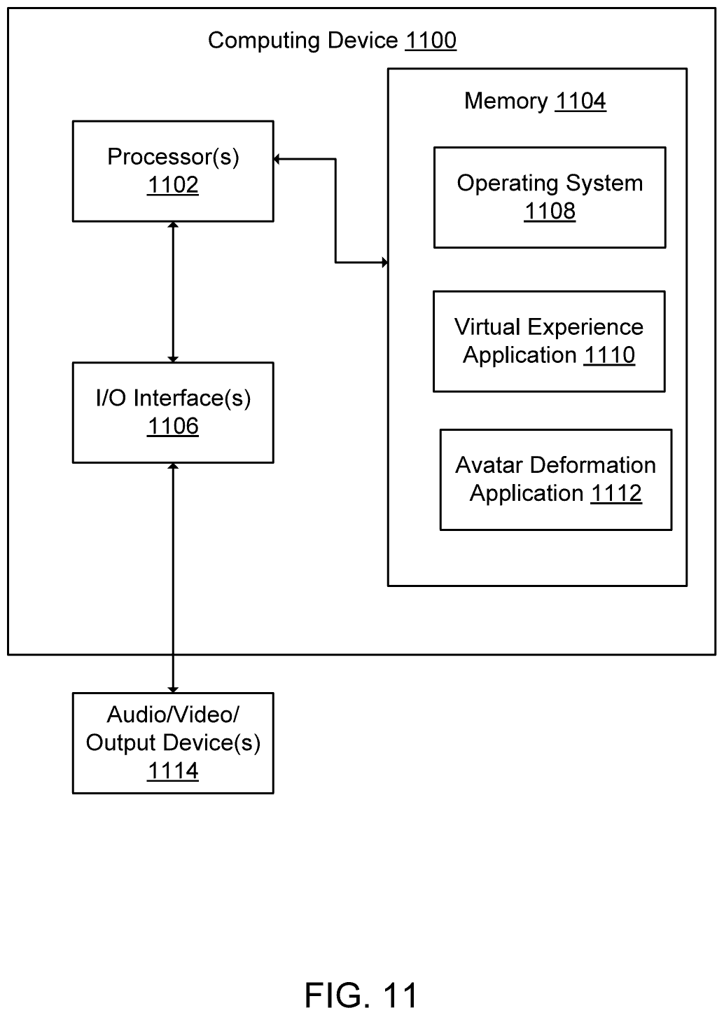

For the sake of simplicity, the various operations in the method 900 are described in the context of a virtual experience (VE) application at a client device performing the operations. However, and as is described later below with respect to FIGS. 1 and 11, some of the operations of the method 900 and/or any other method described herein may be performed alternatively or additionally, in whole or in part, by a VE engine at a VE platform located at a server.

The example method 900 may include one or more operations illustrated by one or more blocks, such as blocks 902 to 908. The various blocks of the method 900 and/or of any other process(es) described herein may be combined into fewer blocks, divided into additional blocks, supplemented with further blocks, and/or eliminated based upon the implementation.

The method 900 of FIG. 9 is explained herein with reference to some of the elements illustrated in at least some of FIGS. 1-8 and 11. In one implementation, the operations of the method 900 may be performed in a pipelined sequential manner. In other implementations, some operations may be performed out-of-order, in parallel, etc.

At block 902, a scaling control is applied to a body part of an avatar body (e.g., a 3D avatar model). For example, the body part may be a head of the avatar body. The scaling control is applied to change a size of at least one component of the body part, such as a jaw, lips, eyes, cars, a forehead, eyebrows, eyelashes, checks, a chin, a nose, a face, or hair of a head of the avatar body, such as illustrated in the example of FIG. 3. In one implementation, applying the scaling control comprises specifying a target scale at each vertex of a mesh of the body part of the avatar body. Block 902 may be followed by block 904.

At block 904, a positional control is applied to the body part of the avatar body. The positional control may be applied to change a shape and a location of at least one component of the body part, such as illustrated in the example of FIGS. 4 and 7. In one implementation, applying the positional control comprises manipulating at least one of the shape and the position of at least one component of the body part to satisfy at least one positional constraint. Block 904 may be followed by block 906.

At block 906, an orientation control is applied to the body part of the avatar body. The orientation control may be applied to change an orientation of at least one component of the body part, such as illustrated in the examples of FIGS. 5 and 8. In one implementation, applying the orientation control comprises controlling surface normals of the at least one component to satisfy at least one orientation constraint.

FIG. 9 illustrates an example method in which a scaling control is applied at block 902, a positional control is applied at block 904, and an orientation control is applied at block 906. However, in various implementations it is possible to omit some of these controls and/or to apply these controls in a different order.

At block 908, the body part of the avatar body may be deformed based on minimizing an energy function of the avatar. For example, the energy function to be minimized may be written (as discussed with respect to FIG. 6) as Equation 1, V′=arg min_{V′}E(V, V′, F) and/or Equation 2, E(V′, R, S)=Σ_{k∈V}Σ_{ij∈N(k)}wᵢⱼ∥sₖRₖ(vⱼ−vᵢ)−(v′ⱼ−vᵢ′)∥²+λₖaₖ∥Rₖnₖ−tₖ∥². The definitions of the variables in Equation 1 and Equation 2 are provided in the discussion of FIG. 6. Additional specifics of how to minimize these energy functions are provided with respect to FIG. 10. Once the body part of the avatar body is deformed, the avatar body is modified and may be used accordingly.

### FIG. 10—Implementing Stylizing a 3D Avatar Body

FIG. 10 is a flowchart of an example computer-implemented method 1000 executable in a three-dimensional (3D) environment to implement stylizing a three-dimensional (3D) avatar body, in accordance with some implementations. Method 1000 may begin at block 1002.

For the sake of simplicity, the various operations in the method 1000 are described in the context of a virtual experience (VE) application at a client device performing the operations. However, and as is described later below with respect to FIGS. 1 and 11, some of the operations of the method 1000 and/or any other method described herein may be performed alternatively or additionally, in whole or in part, by a VE engine at a VE platform located at a server.

The example method 1000 may include one or more operations illustrated by one or more blocks, such as blocks 1002 to 1020. The various blocks of the method 1000 and/or of any other process(es) described herein may be combined into fewer blocks, divided into additional blocks, supplemented with further blocks, and/or eliminated based upon the implementation.

The method 1000 of FIG. 10 is explained herein with reference to some of the elements illustrated in at least some of FIGS. 1-8 and 11. In one implementation, the operations of the method 1000 may be performed in a pipelined sequential manner. In other implementations, some operations may be performed out-of-order, in parallel, etc.

At block 1002, an energy formula is determined. For example, the energy formula to be minimized may be written (as discussed with respect to FIG. 6) as Equation 1, V′=arg min_{V′}E(V, V′, F) and/or Equation 2, E(V′, R, S)=Σ_{k∈V}Σ_{ij∈N(k)}wᵢⱼ∥sₖRₖ(vⱼ−vᵢ)−(v′ⱼ−vᵢ′)∥²+λₖaₖ∥Rₖnₖ−tₖ∥². The definitions of the variables in Equation 1 and Equation 2 are provided in the discussion of FIG. 6. By choosing values that minimize the value of the energy formula, high-quality results may be achieved. It may be empirically found that the as conformal as possible term (angle difference) provides visually plausible deformation. Hence, angle difference may be a good metric as to whether the deformation is good or not. Block 1002 may be followed by block 1004.

At block 1004, it is determined whether a scaling control is being applied. If so, block 1004 is followed by block 1006. If not, block 1004 is followed by block 1008.

At block 1006, a target scale is specified at each vertex of a mesh. Such an action is taken to implement a scaling control (as identified in block 1004). For example, to control the scale, an implementation may prescribe the target scale of each vertex sₖ in Equation 2. With respect to controlling the scale, the scaling control can be used to prescribe the value(s) of a target scale of each vertex sₖ (see, e.g., Equation 2). Such value(s) influence the local step in the optimizer (e.g., changes the output Rₖ in Equation 2) (performed at block 1016) and thus influences the global step (performed at block 1018). Block 1006 may be followed by block 1008.

At block 1008, it is determined whether a positional control is being applied. If so, block 1008 is followed by block 1010. If not, block 1008 is followed by block 1012.

At block 1010, a shape or position is manipulated to satisfy a constraint. Such an action is taken to implement a positional control (as identified in block 1008). With respect to positional constraints, implementations of the positional control can be realized by setting constraints on the global step (e.g., solving a system of linear equations). In some implementations, let the system of linear equations in the global step be as follows: Ax=b (Equation 3) which corresponds to minimizing a quadratic energy E(x)=1/2 x′Ax−x′b+constant (Equation 4).

As discussed with respect to FIG. 6, adding positional constraints cᵢ means that the following optimization problem is to be solved: minₓ 1/2 x′Ax−x′b+constant, subject to xᵢ=cᵢ for all i in the constraints. Additional aspects of solving this optimization problem are discussed in the context of FIG. 6, and involve reformulating the linear system and performing a concatenation to identify a final solution that satisfies the positional constraints. These positional constraints may then be used to manipulate the shape and the position of individual components. Block 1010 may be followed by block 1012.

At block 1012, it is determined whether an orientation control is being applied. If so, block 1012 is followed by block 1014. If not, block 1012 is followed by block 1016.

At block 1014, surface normals are controlled. Such an action is taken to implement an orientation control (as identified in block 1012). With respect to orientation constraints, implementations of the orientation control may be based on specifying target normal vectors tₖ in the context of Equation 2. The controlling of surface normal may occur as discussed with respect to the example presented in FIG. 8.

As noted in FIG. 8, the target normals control the style of the model. As discussed with respect to FIG. 8, the first use case is setting tₖ=nₖ equal to the input normals. This use case may lead to a style preserving deformation. There may also be cases in which normals are enabled or disabled, leading to different variants of the original model. If the user wishes to stylize a shape, the user can choose tₖ to be something else to control the overall shape. Different shapes in the model (such as jaw shapes) may be generated by setting the target normals to closest normals, such as cubic shape normals as follows: tₖ=ClosestCubicNormal(nₖ) (Equation 7). As discussed above cubic normal are only an example choice of normals, and other normals may be chosen instead. Block 1014 may be followed by block 1016.

FIG. 10 illustrates an implementation in which it is determined if a scaling control is applied at block 1004, a positional control is applied at block 1008, and an orientation control is applied at block 1012. However, it is possible to omit some of these controls and/or to apply the controls in a different order. Additionally, the implementations of the controls may occur after the application of multiple types of controls is identified, rather than occurring immediately after the checks, one at a time.

At block 1016, a local step is performed. Specifically, the local step involves computing the optimal rotation Rₖ by solving a small 3×3 singular value decomposition followed by computing the optimal value to scale sₖ, as discussed above. Block 1016 may be followed by block 1018.

At block 1018, a global step is performed. The global step may include solving a system of linear equations, as defined previously in portions of FIG. 10, such as block 1006, block 1010, and/or block 1014. Additional aspects of the global step are discussed above. Block 1018 may be followed by block 1020.

At block 1020, a deformed body part is output. For example, the deformed body part may be output as a mesh based on the input mesh that looks closer to an output head, where the output head is defined by applying one or more from the group comprising: scaling controls, positional controls, and orientation controls.

Hence, these techniques effectively identify modifications to be made to stylize a three-dimensional (3D) avatar body (such as a head). Once the modifications have been identified, techniques provide ways to efficiently perform the stylization by minimizing an energy function that deforms the 3D avatar body with improved computational efficiency.

### FIG. 11—Example Computing Device

FIG. 11 is a block diagram illustrating an example computing device 1100, in accordance with some implementations.

In one example, computing device 1100 may be used to implement a computer device (e.g., 102 and/or 110 of FIG. 1), and perform appropriate method implementations described herein. Computing device 1100 can be any suitable computer system, server, or other electronic or hardware device. For example, the computing device 1100 can be a mainframe computer, desktop computer, workstation, portable computer, or electronic device (portable device, mobile device, cell phone, smartphone, tablet computer, television, TV set top box, personal digital assistant (PDA), media player, game device, wearable device, etc.). In some implementations, computing device 1100 includes a processor 1102, a memory 1104, input/output (I/O) interface 1106, and audio/video input/output devices 1114.

Processor 1102 can be one or more processors and/or processing circuits to execute program code and control basic operations of the computing device 1100. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1104 is typically provided in computing device 1100 for access by the processor 1102, and may be any suitable processor-readable storage medium, e.g., random access memory (RAM), read-only memory (ROM), Electrical Erasable Read-only Memory (EEPROM), Flash memory, etc., suitable for storing instructions for execution by the processor, and located separate from processor 1102 and/or integrated therewith. Memory 1104 can store software operating on the computing device 1100 by the processor 1102, including an operating system 1108, a virtual experience application 1110, an avatar deformation application 1112, and other applications (not shown). In some implementations, application 1110 and/or application 1112 can include instructions that enable processor 1102 to perform the functions (or control the functions of) described herein, e.g., some or all of the methods described with respect to FIGS. 9-10.

For example, applications 1110 can include an avatar deformation application 1112, which as described herein can stylize a three-dimensional (3D) avatar efficiently within an online virtual experience server (e.g., 102). Elements of software in memory 1104 can alternatively be stored on any other suitable storage location or computer-readable medium. In addition, memory 1104 (and/or other connected storage device(s)) can store instructions and data used in the features described herein. Memory 1104 and any other type of storage (magnetic disk, optical disk, magnetic tape, or other tangible media) can be considered “storage” or “storage devices.”

I/O interface 1106 can provide functions to enable interfacing the computing device 1100 with other systems and devices. For example, network communication devices, storage devices (e.g., memory and/or data store 120), and input/output devices can communicate via interface 1106. In some implementations, the I/O interface can connect to interface devices including input devices (keyboard, pointing device, touchscreen, microphone, camera, scanner, etc.) and/or output devices (display device, speaker devices, printer, motor, etc.).

The audio/video input/output devices 1114 can include a user input device (e.g., a mouse, etc.) that can be used to receive user input, a display device (e.g., screen, monitor, etc.) and/or a combined input and display device, that can be used to provide graphical and/or visual output.

For ease of illustration, FIG. 11 shows one block for each of processor 1102, memory 1104, I/O interface 1106, and software blocks of operating system 1108, virtual experience application 1110, and avatar deformation application 1112. These blocks may represent one or more processors or processing circuitries, operating systems, memories, I/O interfaces, applications, and/or software engines. In other implementations, computing device 1100 may not have all of the components shown and/or may have other elements including other types of elements instead of, or in addition to, those shown herein. While the online virtual experience server 102 is described as performing operations as described in some implementations herein, any suitable component or combination of components of online virtual experience server 102 or similar system, or any suitable processor or processors associated with such a system, may perform the operations described.

A user device can also implement and/or be used with features described herein. Example user devices can be computer devices including some similar components as the computing device 1100, e.g., processor(s) 1102, memory 1104, and I/O interface 1106. An operating system, software and applications suitable for the client device can be provided in memory and used by the processor. The I/O interface for a client device can be connected to network communication devices, as well as to input and output devices, e.g., a microphone for capturing sound, a camera for capturing images or video, a mouse for capturing user input, a gesture device for recognizing a user gesture, a touchscreen to detect user input, audio speaker devices for outputting sound, a display device for outputting images or video, or other output devices. A display device within the audio/video input/output devices 1114, for example, can be connected to (or included in) the computing device 1100 to display images pre- and post-processing as described herein, where such display device can include any suitable display device, e.g., an LCD, LED, or plasma display screen, CRT, television, monitor, touchscreen, 3-D display screen, projector, or other visual display device. Some implementations can provide an audio output device, e.g., voice output or synthesis that speaks text.

One or more methods described herein (e.g., methods 900 and 1000) can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., Field-Programmable Gate Array (FPGA), Complex Programmable Logic Device), general purpose processors, graphics processors, Application Specific Integrated Circuits (ASICs), and the like. One or more methods can be performed as part of or component of an application running on the system, or as an application or software running in conjunction with other applications and operating systems.

One or more methods described herein can be run in a standalone program that can be run on any type of computing device, a program run on a web browser, a mobile application (“app”) run on a mobile computing device (e.g., cell phone, smart phone, tablet computer, wearable device (wristwatch, armband, jewelry, headwear, goggles, glasses, etc.), laptop computer, etc.). In one example, a client/server architecture can be used, e.g., a mobile computing device (as a client device) sends user input data to a server device and receives from the server the final output data for output (e.g., for display). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

The functional blocks, operations, features, methods, devices, and systems described in the present disclosure may be integrated or divided into different combinations of systems, devices, and functional blocks as would be known to those skilled in the art. Any suitable programming language and programming techniques may be used to implement the routines of particular implementations. Different programming techniques may be employed, e.g., procedural or object-oriented. The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method to stylize a three-dimensional (3D) avatar body, the method comprising:
performing at least one from the group comprising:
applying a scaling control to a body part of the avatar body to change a size of at least one component of the body part;
applying a positional control to the body part of the avatar body to change at least one from the group of a shape of the at least one component of the body part, a position of the at least one component of the body part, and a combination thereof;
applying an orientation control to the body part of the avatar body to change an orientation of the at least one component of the body part; and
combinations thereof; and
deforming the body part of the avatar body based on minimizing an energy function associated with at least one from the group comprising: the scaling control, the positional control, the orientation control, and combinations thereof.

2. The computer-implemented method of claim 1, wherein minimizing the energy function comprises using a local-global solver to perform a local step and a global step, wherein the local step comprises computing an optimal rotation by solving a singular value decomposition and the global step comprises solving a system of linear equations.

3. The computer-implemented method of claim 2, wherein applying the positional control comprises satisfying at least one positional constraint by adding positional constraints when performing the global step.

4. The computer-implemented method of claim 1, wherein applying the scaling control comprises specifying a target scale at respective vertices of a mesh of the body part of the avatar body.

5. The computer-implemented method of claim 1, wherein applying the positional control comprises manipulating at least one of the shape and the position of the at least one component of the body part to satisfy at least one positional constraint.

6. The computer-implemented method of claim 1, wherein applying the orientation control comprises controlling surface normals of the at least one component to satisfy at least one orientation constraint.

7. The computer-implemented method of claim 6, wherein controlling surface normals comprises setting target normals to closest cubic shape normals.

8. The computer-implemented method of claim 1, wherein the body part of the avatar body comprises a head.

9. The computer-implemented method of claim 1, wherein the at least one component of the body part includes one or more from the group of: a jaw, lips, eyes, ears, a forehead, eyebrows, eyelashes, cheeks, a chin, a nose, a face, hair, and combinations thereof.

10. A non-transitory computer-readable medium with instructions stored thereon that, responsive to execution by a processing device, cause the processing device to perform operations to stylize a three-dimensional (3D) avatar body comprising:
performing at least one from the group comprising:
applying a scaling control to a body part of the avatar body to change a size of at least one component of the body part;
applying a positional control to the body part of the avatar body to change at least one from the group of a shape of the at least one component of the body part, a position of the at least one component of the body part, and a combination thereof;
applying an orientation control to the body part of the avatar body to change an orientation of the at least one component of the body part; and
combinations thereof; and
deforming the body part of the avatar body based on minimizing an energy function associated with at least one from the group comprising: the scaling control, the positional control, the orientation control, and combinations thereof.

11. The non-transitory computer-readable medium of claim 10, wherein minimizing the energy function comprises using a local-global solver to perform a local step and a global step, wherein the local step comprises computing an optimal rotation by solving a singular value decomposition and the global step comprises solving a system of linear equations.

12. The non-transitory computer-readable medium of claim 11, wherein applying the positional control comprises satisfying at least one positional constraint by adding positional constraints when performing the global step.

13. The non-transitory computer-readable medium of claim 10, wherein applying the scaling control comprises specifying a target scale at respective vertices of a mesh of the body part of the avatar body.

14. The non-transitory computer-readable medium of claim 10, wherein applying the positional control comprises manipulating at least one of the shape and the position of the at least one component of the body part to satisfy at least one positional constraint.

15. The non-transitory computer-readable medium of claim 10, wherein applying the orientation control comprises controlling surface normals of the at least one component to satisfy at least one orientation constraint.

16. A system, comprising:
a memory with instructions stored thereon; and
a processing device, coupled to the memory, the processing device configured to access the memory and execute the instructions, wherein the instructions cause the processing device to perform operations to stylize a three-dimensional (3D) avatar body comprising:
performing at least one of:
performing at least one from the group comprising:
applying a scaling control to a body part of the avatar body to change a size of at least one component of the body part;
applying a positional control to the body part of the avatar body to change at least one from the group of a shape of the at least one component of the body part, a position of the at least one component of the body part, and a combination thereof;
applying an orientation control to the body part of the avatar body to change an orientation of the at least one component of the body part; and
combinations thereof; and
deforming the body part of the avatar body based on minimizing an energy function associated with at least one from the group comprising: the scaling control, the positional control, the orientation control, and combinations thereof.

17. The system of claim 16, wherein minimizing the energy function comprises using a local-global solver to perform a local step and a global step, wherein the local step comprises computing an optimal rotation by solving a singular value decomposition and the global step comprises solving a system of linear equations.

18. The system of claim 17, wherein applying the positional control comprises satisfying at least one positional constraint by adding positional constraints when performing the global step.

19. The system of claim 16, wherein applying the scaling control comprises specifying a target scale at respective vertices of a mesh of the body part of the avatar body.

20. The system of claim 16, wherein applying the orientation control comprises controlling surface normals of the at least one component to satisfy at least one orientation constraint.
